(19) United States
(12) Patent Application Publication
(10) Pub. No.: US 2005/0050174 A1
(43) Pub. Date: Mar. 3, 2005

(54) NETWORK SYSTEM HAVING AUTOMATIC CLIENT CONFIGURATION AND METHOD THEREOF

(76) Inventor: Shao-Tsu Kung, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,044

(22) Filed: Sep. 3, 2003

(51) Int. Cl. G06F 15/177

(52) U.S. Cl. 709/220

(57) ABSTRACT

A server includes a configuration file for storing configurations for clients requesting communication with the server. A client includes a memory for storing a set configuration. When the client requests a configuration from the server, the server sends a configuration to the client and the client sets the configuration into the memory to establish communication. A first program executable on the server measures a time since the configuration was sent to the client, allowing the client to connect to the server with that configuration for a predetermined time or until another connection request is made by the client. A second program executable on the client loads a configuration received by the client into the memory when the received configuration complies with a predetermined standard, and loads a default configuration into the memory when the received configuration does not comply with the predetermined standard.

### BACKGROUND OF INVENTION

1. Field of the Invention

The present invention relates to computers, and more specifically, to a computer network having a server and a plurality of clients (mobile units).

2. Description of the Prior Art

Computer networks have changed the way we live and work. No longer is it necessary to exchange information using hardcopies or digital copies on removable computer readable media; fast, efficient, and relatively inexpensive wireless or wired networks can be used instead. As network technologies are developed, it is increasingly common for users to operate their computers while connected to some kind of network in order to share information and resources.

FIG. 1 illustrates a common situation in network use: physical movement of a client from one network environment to another. Consider the networks 10 and 20 shown in Fig. 1. The network 10 has a server 12 and two client computers 14 and 16, while the network 20 is controlled by a server 22 that serves one client 24. Another client 26 is shown moving between the two networks, that is, moving from the network 10 to the network 20. The client 26 may be moved between the networks 10, 20 in a variety of ways and for numerous reasons. For example, if the networks 10, 20 are wireless and the client 26 has a suitable wireless network card, then such movement could be the result of a mobile user carrying his laptop computer between wireless local area networks (LANs). If, on the other hand, the networks 10, 20 are wired (e.g. thought Ethernet cable), then a user may be taking a portable computer system from a wired office network to a wired personal home network. Other situations are increasingly common these days, such as transition between a wired and a wireless network. Regardless of the situation, as the client 26 had been formerly operating in the network 10, it has an existing configuration 28, such as an Internet protocol (IP) address, valid in the network 10. However, upon entering the network 20, the validity of the last configuration 28 is questionable, and a new configuration likely needs to be set in order for the client computer 26 to be able to access information and resources with the server 20.

Currently, configuration of the client for communication with a given network is largely done manually. That is, when a user moves their computer from one network environment to another, they must input a suitable configuration in order for the computer to function in the new environment.

### SUMMARY OF INVENTION

It is therefore a primary objective of the claimed invention to provide a network system capable of automatically assigning a configuration to a client computer.

Briefly summarized, the claimed invention includes a server comprising a configuration file for storing configurations for clients requesting communication with the server, the configurations comprising unique identifications for the clients; a processor for controlling operations of the server and selecting configurations for clients; and a transceiver for communicating with clients according to set configurations of the clients. The claimed invention further includes at least a client for communicating with the server according to a set configuration, the client comprising; a transceiver for communicating with the server according to a set configuration; a memory for storing the set configuration of the client; and a processor for controlling operations of the client and generating a configuration request for the transceiver to send to the server. When the processor of the client requests a configuration from the server, the server sends a configuration to the client and the client loads the configuration into the memory to establish communication between the server and the client.

According to the claimed invention, a first program executable on the processor of the server is capable of measuring a time since a configuration was sent to the client through the transceiver, and allowing the client to connect to the server with that configuration for a predetermined time or until another connection request is made by the client.

According to the claimed invention, a second program executable on the processor of the client is capable of loading a configuration received by the transceiver of the client into the memory when the received configuration complies with a predetermined standard, and loading a default configuration into the memory when the received configuration does not comply with the predetermined standard.

It is an advantage of the claimed invention that communication between the server and the client can be established without user input.

It is a further advantage of the claimed invention that the server can serve both clients according to the claimed invention and those according to the prior art.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of computer networks according to the prior art.

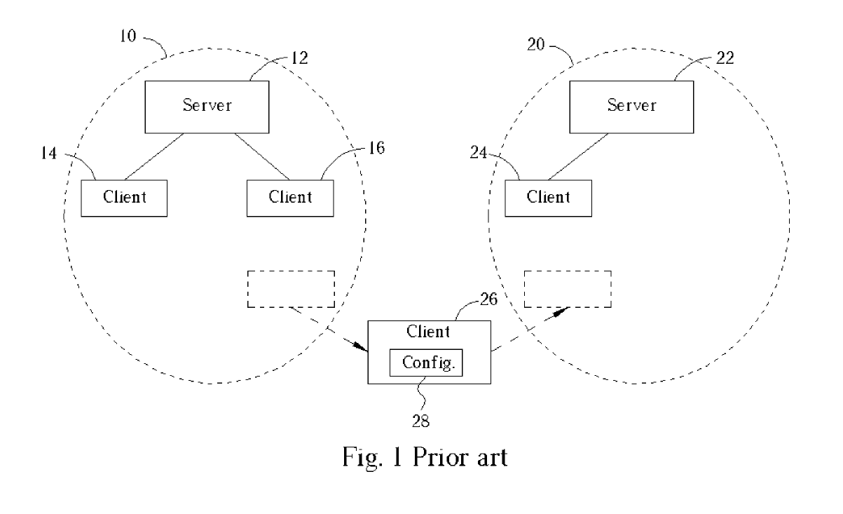

FIG. 2 is a schematic diagram of a network system according to the present invention.

FIG. 3 is a flowchart of a method according to the present invention.

FIG. 4 is a flowchart of a method performed on the server of FIG. 2.

### DETAILED DESCRIPTION

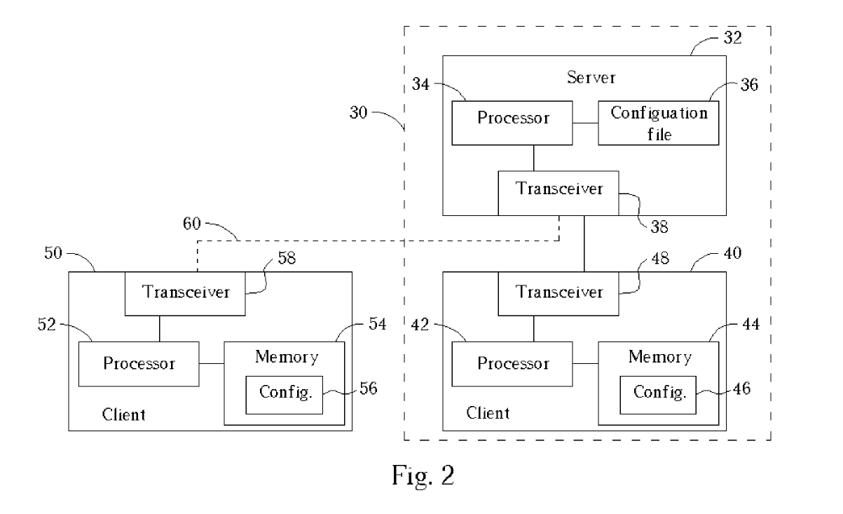

FIG. 2 illustrates a network system according to the preferred embodiment of the present invention. A computer network 30 is controlled by a server 32. The network 30 can be of well-known design, such as a wired Ethernet network or an IEEE 802.11 wireless network. The server 32 is shown in communication with a client 40 and establishing communication with a client 50; only two clients are illustrated for conciseness, more are typical. The network peripherals of the server 32 and the clients 40, 50 are suitable for wired, wireless, or both types of networks.

The server 32 is a full computer system including a power supply, main board, random-access memory (RAM), mass storage device, and user interface (display device and input device). In FIG. 2, only elements directly relevant to the present invention are illustrated. According to the present invention, the server comprises a processor 34 such as a CPU on the main board, a configuration file 36 stored in the mass storage device or RAM, and a transceiver 38 being a network adaptor for wired and/or wireless networks. The server 32 supports two main communications modes with a client, preliminary and established. In the preliminary mode, the server 32 can communicate, in a limited way, with any client that is in range (wireless) or physically connected (wired) to facilitate forming the established connection. In the established connection, resources of the server 32, such as an IP address, are dedicated to the client and the server 32 communicates with the client according to a unique identification such that general communications and wholesale data transfers are possible. The processor 34 includes a timer or clock, and controls operations of the server 32 and manages the network connections of the clients 40, 50 and any other clients.

Similar to the server 32, the client 40 is a full computer system including a power supply, main board, random-access memory (RAM), mass storage device, and user interface (display device and input device). The client 40 can be a portable notebook computer, desktop computer, personal digital assistant (PDA), or the like. Regardless of the exact setup of the client 40, it includes a processor 42, a memory 44 storing a network configuration 46, and a transceiver 48 being a suitable network adaptor (wired or wireless) for communication with the server 32. The processor 42 is a CPU of the client computer 40. The memory can be a general purpose RAM or a nonvolatile memory of the network adaptor 48 such as a flash memory. The client 40 communicates with the server 32 according to the configuration 46 stored in the memory. That is, data transfers between the client 40 and the server 32 are identified by an identification number (e.g. IP address) unique to the configuration 46.

The second client 50 is similar to the previously described client 40. The client 50 includes a processor 52, a memory 54 storing a network configuration 56, and a transceiver 58 being a suitable network adaptor (wired or wireless) for communication with the server 32. A key difference between the client 50 and the client 40 is that the configuration 56 of the client 50 is of unknown type. That is, the configuration 56 may be compatible or incompatible with the network 32; and even if compatible it may be represent an already assigned unique identification (another client of the network 30 may be using the configuration 56). When the client 50 moves into network 30 forming a preliminary connection 60, by either entering the effective range in the case of a wireless network or being physically connected to a network cable in the case of a wired network, the present invention configuration method is performed over the preliminary connection 60 with the aim of establishing the connection.

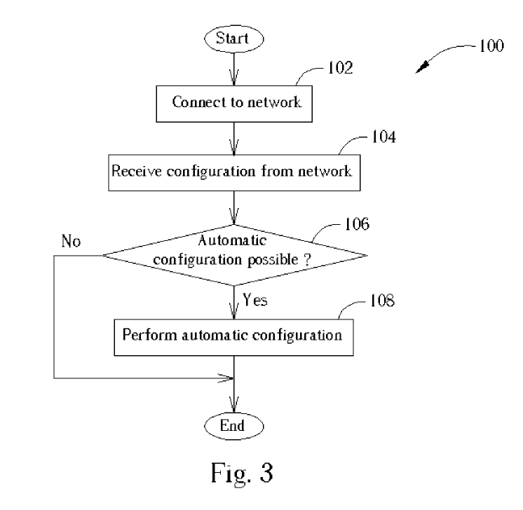

Referring to a process 100 illustrated by the flowchart of FIG. 3, operation of the present invention is described. In step 102, the client 50 becomes connected to the network 30 through the preliminary connection 60, by either coming into range of or being physically plugged into the server 32. That is, the transceiver 58 of the client 50 and the transceiver 38 of the server 32 become connected such that limited information transfer is possible. Then, as shown in step 104, the client 50 receives a configuration from the server 32. In step 106, determination of whether or not the client 50 is capable of automatic configuration is made. If the client 50 is capable of automatic configuration, then this is performed in step 108 and the connection 60 to the server 32 becomes fully established. When the client 50 is not capable of performing an automatic configuration based on the configuration information received in step 104, the client 50 either uses a default configuration or prompts a user to enter suitable configuration information. Specifically, if the configuration does not meet a predetermined standard, that is, it is incorrect or of the wrong kind, the client 50 uses a suitable default configuration.

In step 106, if the client 50 cannot perform an automatic configuration, the server 32 can determine this in two ways. First, the server 32 can determine the time since the configuration was sent to the client 50. If the client 50 does not establish the connection after a predetermined time, then the server 32 determines that the client 50 cannot perform an automatic configuration (the client is not of present invention design for this type of network). The second way is if the server 32 receives another connection request from the client 50 after having sent the configuration information, the server can determine that the client 32 cannot perform automatic configuration. Upon determining that the client 50 cannot support an automatic configuration, the server 32 can disallow connection of the client 50 under the sent configuration, and free that configuration for use by another client. In this way, the server 32 can accommodate present invention clients and prior art clients.

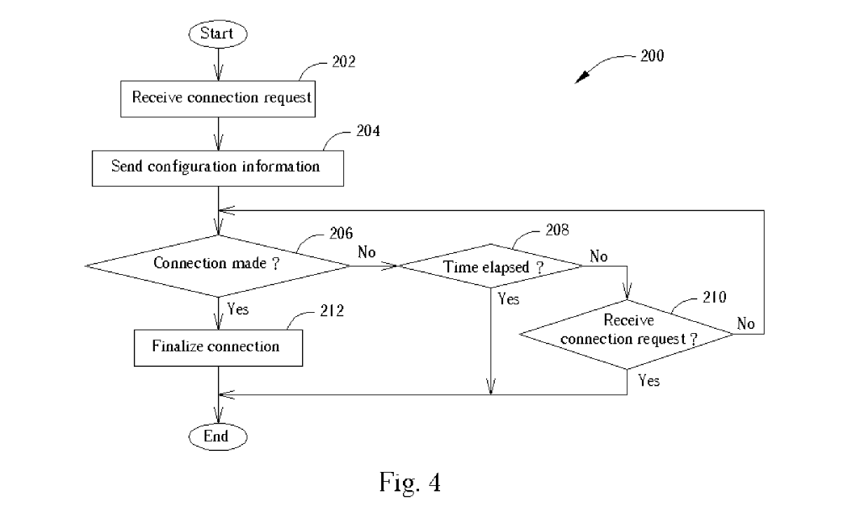

FIG. 4 illustrates a process 200 that the server 32 performs. After receiving a connection request from the client 50 in step 202, the server 32 sends configuration information in step 204. The server 32 then determines if the client 50 makes the connection in step 206. If the connection is not made, the server 32 checks the time elapsed (step 208) since the configuration information was sent and checks if another connection request is made by the same client (step 210). If the time elapsed passes a predetermined time or the client 50 makes another connection request, the server 32 determines that the client cannot perform an automatic configuration and the process 200 ends. The server 32 can then use the configuration for another client. In step 206, when the connection is made by the client, the server can finalize the connection (if required) in step 212.

The present invention method can be realized though software programs the on both the client and the server. The program executed by the client simply has to configure the transceiver based on the received configuration information according to the above description. The client program should also have provisions for a default configuration or a user prompt for when the received configuration information is unsuitable. The server software is according to FIG. 4 and the above description. The exact specifications of the software will depend on the specific network concerned (wired/wireless LAN, portable radio phone) and the specifics of the clients and server.

In contrast to the prior art, the present invention method eliminates the need for a user to manually enter configuration information when connecting a client to a server. More convenient and smooth network connections are thus possible, especially in situations where transitions between networks are frequent.

Those skilled in the art will readily observe that numerous modifications and alterations of the device may be made while retaining the teachings of the invention. Accordingly, the above disclosure should be construed as limited only by the metes and bounds of the appended claims.

1. A network system comprising:
a server comprising:
a configuration file for storing configurations for clients requesting communication with the server, the configurations comprising unique identifications for the clients;
a processor for controlling operations of the server and selecting configurations for clients; and
a transceiver for communicating with clients according to set configurations of the clients;
at least a client for communicating with the server according to a set configuration, the client comprising:
a transceiver for communicating with the server according to a set configuration;
a memory for storing the set configuration of the client; and
a processor for controlling operations of the client and generating a configuration request for the transceiver to send to the server;
wherein when the processor of the client requests a configuration from the server, the server sends a configuration to the client and the client loads the configuration into the memory to establish communication between the server and the client.

2. The network system of claim 1 wherein the transceivers are adapted to communicating via a wired or wireless network.

3. The network system of claim 1 further comprising a first program executable on the processor of the server, the first program capable of measuring a time since a configuration was sent to the client through the transceiver, and allowing the client to connect to the server with that configuration for a predetermined time or until another connection request is made by the client.

4. The network system of claim 1 further comprising a first program executable on the processor of the server, the first program capable of measuring a time since a configuration was sent to the client through the transceiver, and allowing the client to connect to the server with that configuration for a predetermined time.

5. The network system of claim 1 further comprising a first program executable on the processor of the server, the first program capable of allowing the client to connect to the server with that configuration until another connection request is made by the client.

6. The network system of claim 1 further comprising a second program executable on the processor of the client, the second program capable of loading a configuration received by the transceiver of the client into the memory when the received configuration complies with a predetermined standard, and loading a default configuration into the memory when the received configuration does not comply with the predetermined standard.

7. A network server for communication with at least a client, the network server comprising:
a configuration file for storing configurations for clients requesting communication with the server, the configurations comprising unique identifications for the clients;
a processor for controlling operations of the server and selecting configurations for clients;
a transceiver for communicating with clients according to set configurations of the clients; and
a first program executable on the processor for measuring a time since a configuration was sent to the client through the transceiver, and allowing the client to connect to the server with the configuration for a predetermined time or until another connection request is made by the client;
wherein when the client requests a configuration from the server, the server sends a configuration to the client to establish communication between the server and the client.

8. The network server of claim 7 wherein the transceiver is adapted to communicating via a wired or wireless network.

9. A client for communicating with the server according to a set configuration, the set configuration comprising a unique identification for the client, the client comprising:
a transceiver for communicating with the server according to a set configuration;
a memory for storing the set configuration of the client;
a processor for controlling operations of the client and generating a configuration request for the transceiver to send to the server; and
a second program executable on the processor for loading a configuration received by the transceiver into the memory when the received configuration complies with a predetermined standard, and loading a default configuration into the memory when the received configuration does not comply with the predetermined standard.

10. The network system of claim 9 wherein the transceiver is adapted to communicating via a wired or wireless network.

11. A method of establishing communication between a server and a client, the method comprising:
requesting a connection to the server with the client;
sending a configuration from the server to the client, the configuration comprising a unique identification for the client;
evaluating the configuration received by the client for compatibility with the client;
loading the configuration into a memory of the client when the configuration is compatible with the client; and
sending confirmation of the loaded configuration from the client to the server;
wherein the server and client communicate over an established connection according to the configuration in the memory of the client.

12. The method of claim 11 further comprising loading a default configuration into the memory of the client when the received configuration is incompatible with the client.

13. The method of claim 11 further comprising allowing connection to the server with the sent configuration for a predetermined time after the sent configuration is sent to the client.

14. The method of claim 11 further comprising allowing connection to the server with the sent configuration until another connection request is made by the client.

15. The method of claim 11 further comprising allowing connection to the server with the sent configuration for a predetermined time after the sent configuration is sent to the client or until another connection request is made by the client.

16. The method of claim 11 wherein the server and client communicate over a wired or wireless network.
